(19) United States
(12) Patent Application Publication
(10) Pub. No.: US 2008/0104402 A1
(43) Pub. Date: May 1, 2008

(54) Countermeasure against fault-based attack on RSA signature verification

(76) Inventors: Shay Gueron, Haifa (IL); Jean-Pierre Seifert, Tirol (AT)

Correspondence Address: INTEL/BLAKELY, 1279 OAKMEAD PARKWAY, SUNNYVALE, CA, 94085-4040, US

(21) Appl. No.: 11/529,857

(22) Filed: Sep. 28, 2006

(51) Int. Cl. H04L 9/00; G06F 12/14; H04L 9/32; G06F 11/30

(52) U.S. Cl. 713/176; 713/181; 713/187

(57) ABSTRACT

Methods and apparatuses enable countermeasures to obstruct a fault-based attack on an authentication procedure. A digital message M, a signature S, and a modulus N are received, where the signature S is to sign the digital message M, and the modulus N is a public modulus for modular authentication operations. In one embodiment, the message and signature are compliant with the RSA algorithm. The signature S is validated, and after validation of the signature S, one or more N-based computations are performed that validate N. In one embodiment, N is validated prior to validating the signature S, and a double-validation countermeasure provides for re-validating N after validating S. In one embodiment, N is validated or re-validated in conjunction with validation of S. N can be validated in conjunction with validation of S through the use of computations with intermediate values derived from a trusted copy of N.

### FIELD

Embodiments of the invention relate to public-key cryptography, and more particularly to authenticating a message signed with a Rivest, Shamir, and Adleman (RSA) compliant signature while reducing the likelihood of success of a fault attack.

### BACKGROUND

Public-key cryptography allows two parties to communicate securely without the need for prior access to a shared secret key. Instead, a pair of mathematically related cryptographic keys, one public and widely distributed, and one private, are used. The private key is kept secret and can be used to form a digital signature, while the public key is made public and can be used to verify the digital signature. Public-key cryptography can be applied to digitally sign a message. A digital signature is conceptually similar to a signet and serves to ensure both the identity of the author and authenticity of the message.

One form of public-key cryptography is the Rivest, Shamir, and Adleman (RSA) algorithm. A standard application of the RSA algorithm to digitally sign a message involves using two randomly generated, large prime numbers, P and Q, from which public and private keys are created. The public key consists of a public exponent, E, and modulus, N, and is distributed to any number of signature authentication devices. A signature authentication device is a device that receives and authenticates a message. The private key consists of a private exponent, D, and the same modulus, N.

A digital signature, S, is created by computing S=M^{D}(mod N), where M is known as the digest of the message and is the hash-value of a pre-defined hash-function (e.g., Secure Hash Algorithm 1 (SHA-1)) performed on the data to be sent, D is the private exponent of the private key, and N is the modulus of the private key. To digitally sign a message M, a sender computes a hash of M and encrypts the resulting hash with the private key <N, D> to form a signature S, then sends M and the S to a receiver.

To authenticate the message, the authentication device first validates the received public key, consisting of a public exponent, E, and modulus, N, by comparing it to an expected value (e.g., a copy known to be valid). The public key is only validated if it is identical to the expected value. If the public key is found to be valid, then the validity of the signature is tested. To validate the signature, a local message digest, R, is computed as the result of the hash function used by the sender, performed on the received message. The authentication device (i.e., the receiver) computes a hash of M, uses the public key <N, E> to decrypt the signature S and extract an expected value, and compares the result to the hash of M. Note that in practice, a padding scheme is typically used, which will generally be assumed herein. Although it is possible to implement the authentication procedures as described herein without padding, a lack of padding generally increases the risk of insecurity in the system, and may nullify the effectiveness of the entire authentication procedure. If the hash of M and the derived expected value match, the signature S is deemed valid as being generated with the private key, and only a valid sender knows the private key. The message M can be considered authentic and not altered since being signed, because changing M also changes the hash of M, and the hash of the altered message would not match the result of decrypting S with the public key.

If an attacker has physical access to the receiving device and is able to induce data faults during the authentication procedure, the traditional RSA signature scheme is vulnerable to a recently developed fault attack. The security of the RSA algorithm is based on the idea that it is very difficult to factor the modulus N. However, in a successful fault attack, the attacker modifies only a few bits of the public modulus N to generate a factorable fake modulus N_{F}. With the fake modulus N_{F}, the attacker uses N_{F} to compute a forged signature S_{F} for a false message M_{F}, and sends S_{F} and M_{F} to the receiving device. During the authentication procedure, the attacker induces data faults and changes the value of the modulus N to N_{F}, causing the receiving device to use the key <N_{F}, E> to decrypt S_{F}. Because the attacker can control the value of the modulus used to decrypt S_{F}, the attacker can cause the traditional RSA signature authentication procedure to accept the false message M_{F} as an authentic message.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of an authentication client having an authentication module.

FIG. 2 is a block diagram of an embodiment of an authentication module.

FIG. 3 is a flow diagram of an embodiment of a process for doubly validating a public key.

FIG. 4 is a flow diagram of an embodiment of a process for interleaving validation of a public key with validation of a received signature.

FIG. 5 is a flow diagram of an embodiment of a process for interleaving validation of a public key with validation of a received signature with computations derived from a trusted public key value.

FIG. 6 is a flow diagram of an embodiment of a process for interleaving validation of a public key with validation of a received signature with computations derived from a trusted public key value.

### DETAILED DESCRIPTION

As used herein, references to one or more “embodiments” are to be understood as describing a particular feature, structure, or characteristic included in at least one implementation of the invention. Phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, with an overview description of embodiments of the invention, followed by a more detailed description with reference to the drawings.

A digital signature can be used to lock a computer system. As used herein, locking a computer system refers to restricting access or use of the system. The manufacturer of the system generates a private key and a public key. The manufacturer keeps the private key secret, and signs messages containing coded instructions with the private key. The manufacturer distributes the public key, which enables a locked system (i.e., an authenticating device restricted by the private key) to authenticate messages signed by the manufacturer with the private key. Generally a locked system only executes code that has been signed with the private key, allowing the manufacturer to regulate and restrict the software that can run on the locked system. For example, the locked system may be a game console that only allows games signed by the console manufacturer to be executed on the console. The console manufacturer can sell licenses to game developers and use the digital signature restrictions to prevent unlicensed or pirated games from running on the console.

The Rivest, Shamir, and Adleman (RSA) algorithm is one form of public-key cryptography that can be used to provide a digital signature. The RSA signature methodology includes three phases: key generation, message signing, and message authentication. Assuming a key owner and an authenticating device as the entities employing the RSA signature methodology, the general flow would be as follows. For key generation, the key owner chooses two secret large prime numbers P and Q, where P≠Q. P and Q can be selected randomly and independently of each other. Methods for selecting P and Q are known, and will not be discussed in detail herein. P and Q are used to compute an authentic modulus N_{A} (where N_{A}=PQ), and a totient φ (where φ=(P-1)(Q-1)). The key owner selects a public exponent E, where E is an integer in the range (0, N_{A}-1). Commonly, E is generated by computing E=2k+1, with k=1, 2, or 8, although other values are possible. The key owner also selects a private exponent D, where D is an integer in the range (0, N_{A}-1) that satisfies the equation DE=1 (mod φ). A private key <N_{A}, D> includes the authentic modulus N_{A} and the private exponent D, and is kept secret by the key owner. A public key <N_{A}, E> includes the same authentic modulus N_{A} and the public exponent E. The public key <N_{A}, E> may be widely distributed, or at least stored on authenticating devices that are to receive and decrypt messages from the key owner. An authenticating device may store the entire public key <N_{A}, E>, or alternatively, store the public exponent E directly, and store only a hash of the authentic modulus hN_{A}. The hash of the authentic modulus, hN_{A} is much smaller than N_{A} (for example, 160 bits for the hash versus 2048 bits for the modulus).

For message signing, the key owner prepares a message M to be signed. The message M may contain code written by the key owner, or may contain code written by a licensed developer. The key owner computes a hash of the message hM. The hash may be computed using, as one example, a Secure Hash Algorithm (SHA) such as SHA-1, or other known algorithms. The key owner encrypts the resulting hash hM with the private key <N_{A}, D> to produce a signature S:

S=hM^{D}mod N_{A}. (1)

The message M and signature S are sent to the authenticating device (e.g., the locked system referred to above). The key owner may also send the authentic modulus N_{A}, which may be used by the authenticating device if the authenticating device does not store a copy of the authentic modulus.

For message authentication, the authenticating device performs various operations on the message and signature received from the key owner. If the authenticating device does not store a copy of the authentic modulus N_{A}, the authenticating device first obtains/accesses a copy of the modulus to complete its public key (for example, receiving the modulus with the message, accessing a public key database, etc.). The authenticating device computes a hash of the received modulus N_{R} and compares it to the stored hash of the authentic modulus hN_{A}. If the two hashes match, the authenticating device uses the received modulus N_{R} to complete its public key, which is then used to validate the received signature S_{R}. If, instead, the authenticating device stores a copy of the entire public key, it retrieves the copy from memory/storage and validates the received signature S_{R}.

To validate the received signature S_{R}, the authenticating device computes a hash of the received message hM_{R} using the same hash algorithm used by the key owner. The knowledge of the authenticating device of the hash algorithm used by the key owner can be assumed for purposes of the discussion herein, as the sharing of such information is understood in the art. The authenticating device decrypts the received signature S_{R} with the public key <N, E>, generating a decrypted result A by performing:

A=S_{R}^{E}(mod N), (2)

where S_{R} is the received signature, and N is either the received modulus N_{R}, or the stored authentic modulus N_{A}, depending on the implementation. The authenticating device compares the decrypted result A to the hash of the received message hM_{R} (which is typically padded). If the result of the comparison indicates a match, the received message M_{R} can be assumed to have been signed with the key owner's private key <N_{A}, D>. Because the private key <N_{A}, D> is assumed to be a secret, the received message M_{R} can be assumed to contain code approved by the key owner, and the authenticating device executes the code in the message. Note that if the message were altered after being signed by the key owner, the change to the message would result in a change to the hash of the message by the authenticating device. Thus, a message that properly authenticates can also be assumed to have not been altered after being signed.

An attacker may have access to the authenticating device, for example, as an owner of the device in physical possession of the device. When an attacker has access to the authenticating device, the traditional RSA signature verification phase may be vulnerable to a fault attack. The fault attack includes two aspects: an off-line false message generation, and an on-line fault generation. With the off-line false message generation, the attacker generates a false message M_{F} and computes a hash of the false message hM_{F}. The false message may be malicious code, as well as being an unauthorized version of code that would otherwise normally be executed on the authenticating device (e.g., a counterfeit game for a console). The security of the RSA algorithm depends on the statistical improbability that the attacker can factor the authentic modulus N_{A}. However, in the case of a fault attack, rather than factor the authentic modulus N_{A}, the attacker selects a fake modulus N_{F} that is easily factorable and varies from the authentic modulus by a small number of bits (e.g., four bits), as described in more detail below. The attacker can be assumed to know the values of the authentic modulus N_{A} and the public exponent E, which are public by definition. For the attack to succeed, the attacker computes a forged signature S_{F}, where S_{F} satisfies the equation

hM_{F}=S_{F}^{E}(mod N_{F}). (3)

If no suitable S_{F} can be found, the attacker selects a different fake modulus N_{F} and tries again. Such operations can be performed offline in preparation for a fault attack on the authenticating device. As used herein, “offline” refers to a state separate from operations on the authenticating device.

With the on-line fault generation, the attacker sends the false message M_{F} and the forged signature S_{F} to the authenticating device. On-line, in contrast to off-line, is a state of operating on the authenticating device. If the authenticating device did not store a copy of the authentic modulus N_{A}, the attacker also sends a copy of the authentic modulus N_{A}. The authenticating device computes a hash of the received modulus N_{R} and compares it to the stored hash of the authentic modulus (i.e., a trusted copy). Because the attacker sent the authentic modulus, the two hashes match and the system uses the received modulus to complete its public key <N, E>. If the system stored a copy of the entire public key, it retrieves the public key <N, E>.

For the fault attack, the attacker induces data faults in the authenticating device, changing bits in the modulus N. Data faults can be induced in a computer system, for example, by causing variations in the supply voltage, by exposing a circuit to intense light (for example, white light or a laser) for a brief time period, or by exposing a circuit to X-rays or ion beams. If the attacker successfully changes the authentic modulus N_{A} into the fake modulus N_{F}, the system uses the key <N_{F}, E>, instead of <N_{A}, E>, to decrypt the forged signature S_{F}. Because S_{F} was chosen to satisfy equation (3), the decrypted result would match the hash of the false message hM_{F}, and the authenticating device would accept the forged message M_{F} as an authentic message.

Inducing data faults in the modulus is a non-deterministic process, meaning that the new value of the modulus is somewhat random. However, the fewer bits that N_{F} varies from N_{A}, the fewer random changes the attacker would need to make, which would increase the probability the changed modulus will be N_{F}. If N_{F} varies from N by b bits, then the expected number of fault induction attempts to successfully transform N into N_{F} is roughly 2b. Thus, the goal of the off-line phase is to find a suitable fake modulus N_{F} that varies from the authentic modulus by as few bits as possible. If the modulus has 1024 bits, the attacker has a better than 50% chance of finding a suitable N_{F} by changing only 4 bits, yielding roughly 8 attempts. If the modulus has 2048 bits, the attacker has a better than 50% chance of finding a suitable N_{F} by changing only 6 bits, yielding roughly 12 attempts. Because success can be achieved with a feasible number of attempts, fault attacks are a substantial threat to the traditional RSA authentication procedure.

As described in more detail below, the probability of success of a fault attack can be limited with one or more countermeasures. In one embodiment, a double validation countermeasure limits the probability of success of a fault attack. A double validation countermeasure provides validating the public modulus N multiple times. N can be validated prior to validating the signature S, and again after validating S. The message is deemed valid only if the validation of S is successful, as well as both validations of N. If the attacker were to induce a fault attack and attempt to change the value of N for the validation of S, the second validation of N would fail unless the attacker could also successfully induce a fault attack after validation of S and change N back.

In one embodiment, one or more countermeasures referred to herein as an “interleaving” countermeasures limit the probability of success of a fault attack. An interleaving countermeasure involves the generation of one or more additional variables derived from the authentic modulus N_{A}, or from the validated modulus N_{R}. During validation of S, one or more computations are performed with the N-derived variable(s) to validate S. If the value of N has been changed through a fault attack, the validation of S will fail, and so the authentication of M will fail.

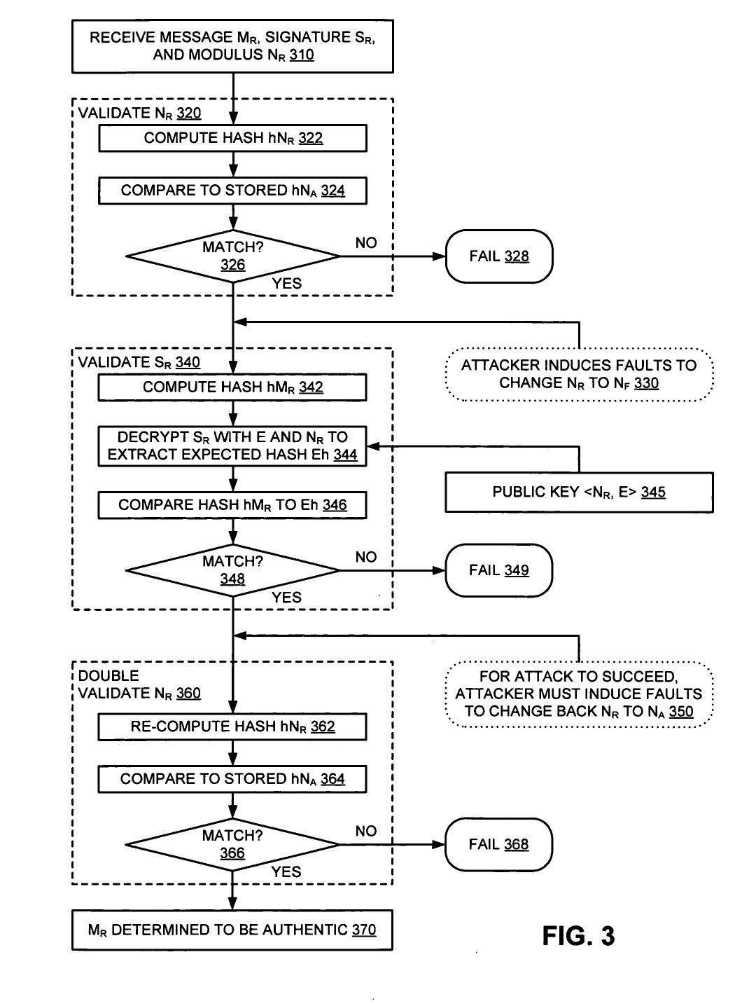

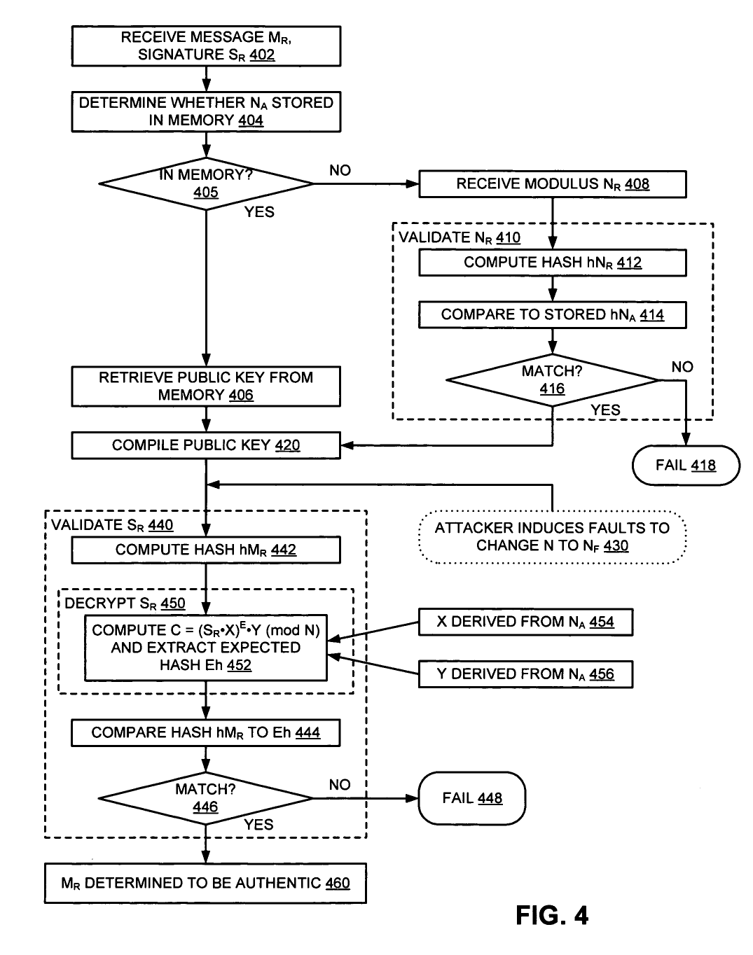

The double validation countermeasure is described in more detail with reference to FIG. 3, and the interleaving countermeasures are described in more detail with reference to FIGS. 4-6.

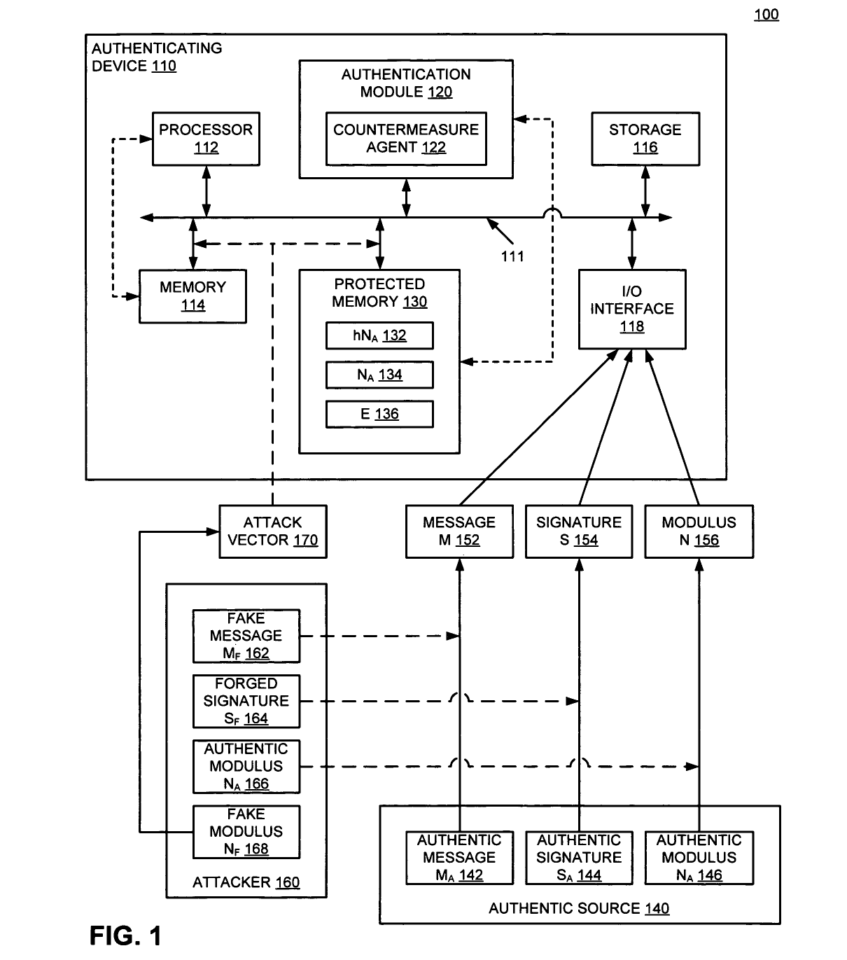

FIG. 1 is a block diagram of an embodiment of an authentication client having an authentication module. System 100 includes authenticating device, which may be, for example, a personal computer, handheld computer, gaming system (e.g., console), set-top box, cell phone, etc. Authenticating device 100 includes one or more processors 112, which may be, for example, one or more microprocessors, central processing units (CPUs), processing cores, etc., to perform operations related to message authentication. Processor 112 controls the overall operation of authenticating device 100, and may be, or may include, one or more programmable general-purpose or special-purpose microprocessors, digital signal processors (DSPs), programmable controllers, application specific integrated circuits (ASICs), programmable logic devices (PLDs), or the similar devices, or a combination of such devices.

Processor 112 is coupled to memory 114, which represents the main memory of authenticating device 100. Processor 112 can be coupled to memory 114 via a bus (e.g., bus 111) common to multiple devices, and/or via a direct connection (e.g., direct memory access (DMA)). Memory 114 provides code and/or data to be executed by processor 112. Memory 114 may include read-only memory (ROM), flash memory, one or more varieties of random access memory (RAM, e.g., static RAM (SRAM), dynamic RAM (DRAM), synchronous DRAM (SDRAM), etc.), or a combination of memory technologies. Memory 114 also includes registers that temporarily store the key values (e.g., public modulus N). The changing of values of the bits in the registers is the source of the fault attacks.

Processor 112 and memory 114 are coupled to bus system 111. Bus system 111 is an abstraction that represents any of one or more separate physical buses, communication lines/interfaces, and/or multi-drop or point-to-point connections, connected by appropriate bridges, adapters, and/or controllers. Therefore, bus system 111 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronic Engineers (IEEE) standard 1394-1995 bus, published Aug. 30, 1996, commonly refereed to as “Firewire.”

In one embodiment, authenticating device 110 includes protected memory 130. Protected memory 130 represents a non-volatile memory that has restricted write access. Protected memory 130 may be strict read-only memory (ROM), a one time programmable read-only memory (OTPROM), a protected electrically erasable programmable read-only memory (EEPROM), Trusted Platform Module (TPM, of the Trusted Computing Group), etc. Protected memory 130 may also have restricted read access. Protected memory 130 may include one or more values stored for the purpose of performing message authentication. For example, protected memory 130 may include a public modulus N_{A} 134, or a hash of the public modulus, hN_{A} 132, as well as the public exponent E 136.

Authenticating device 110 also includes storage 116, which may be or include any conventional medium for storing data in a non-volatile manner. Storage 116 holds data and/or instructions in a persistent state (i.e., the value is retained despite interruption of power to authentication client 200). Storage 116 may include any one or more of a conventional magnetic disk (e.g., hard disk), an optical disk (e.g., CD-ROM (compact disk-read only memory), DVD (digital video/versatile disc) based storage), magneto-optical (MO) storage, semiconductor-based storage (e.g., flash), etc.

Also coupled to processor 112 through bus system 111 are one or more I/O (input/output) interface(s) 118. I/O interfaces 118 may include monitors, displays, audio devices, keyboards, pointer devices, etc. I/O interfaces 118 may include network interfaces to provide hardware and software that connects to devices external to authenticating device 110, and generally includes a network interface adapter (e.g., Ethernet adapter). The network interface may be coupled to any type of network with associated hardware and software components, for example, a local area network (LAN), wide area network (WAN), metropolitan area network (MAN), global area network (GAN) such as the Internet, or any combination thereof. The connectivity hardware may include Category-5 or other twisted pair cable, coaxial cable, wireless communication transceivers, etc., as well as flow direction hardware (e.g., interface circuits/cards, switches, routers, servers).

Authenticating device 110 also includes authentication module 120 that represents hardware and/or software modules that provide authentication functionality. Authentication module 120 includes countermeasure agent 122, which provides the double validation countermeasure and/or an interleaving countermeasure referred to above. With countermeasure agent 122, authentication module 120 can authenticate a received message, while being less susceptible to a fault attack.

Authenticating device 110 may receive a message from authentic source 140, which represents a device manufacturer or other entity authorized to provide code to be executed on authenticating device 110. Authentic source 140 generates authentic message M_{A} 142, signed with authentic signature S_{A} 144. Authentic source 140 may also provide authentic modulus N_{A} 146. Authentic source 140 may provide each component to authenticating device 110, which are received, respectively, as message M 152, signature S 154, and modulus N 156. Authenticating device 110 tests the validity of each component prior to executing the received message.

Attacker 160 may generate fake message M_{F} 162 and forged signature S_{F} 164. Attacker 160 also has access to authentic modulus N_{A} 166, which can also be provided to authenticating device 110. In the fault attack, as described above, attacker 160 attempts to induce a fault to have authenticating device 110 accept fake message M_{F} 162 as an authentic message M_{A} 142.

Attacker 160 generates fake modulus N_{F} 168, which is used to generate forged signature S_{F} 164. Fake modulus N_{F} 168 is provided to authenticating device 110 through attack vector 170, in which attacker 160 attempts to change authentic modulus N_{A} 134 to fake modulus N_{F} 168. Attack vector may be employed at memory 114, for example, when the modulus is loaded into volatile memory, or at the connection to protected memory 130 as the authentic modulus is accessed from the protected memory.

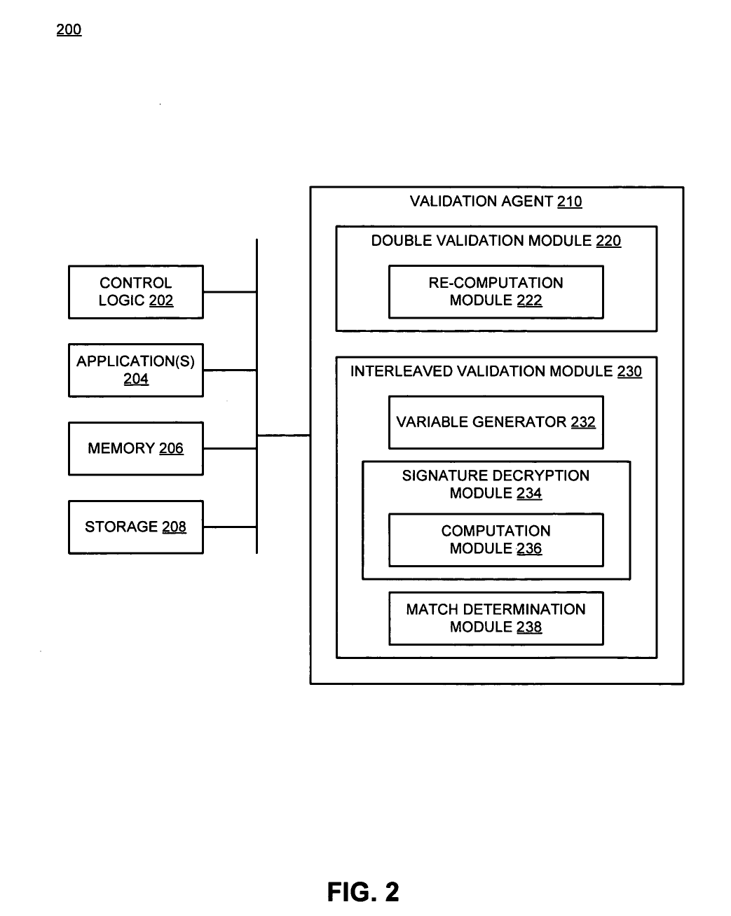

FIG. 2 is a block diagram of an embodiment of an authentication module. Authentication module 200 can be provided as hardware, software, or a combination. As such, certain elements of FIG. 2 may apply to one implementation, but not another, as will be understood by the context. The components or modules of FIG. 2 are means that provide various functions. Authentication module 200 includes control logic 202, which implements logical functional control to direct operation of authentication module 200 (in the case of software components), and/or hardware associated with directing operation of authentication module 200. Logic may be hardware logic circuits and/or software routines. The logic may be instructions executing on a processor of a computing device. In one embodiment, authentication module 200 includes one or more applications 204, which represent code sequences and/or programs that provide instructions to control logic 202.

In one embodiment, authentication module 200 includes memory 206 and/or access to memory resource 206 for storing data and/or instructions. In an implementation in software, memory 206 represents the ability of authentication module 200 to store values to main memory of a system in which authentication module 200 resides. Alternatively, memory 206 represents a memory device managed by or shared by authentication module 200. Memory 206 may include registers, as well as one or more types of RAM.

Authentication module 200 includes storage 208, which represents storage local to authentication module 200. For example, storage 208 may be a restricted access storage device, as discussed above with respect to protected memory 130 of FIG. 1. In an implementation with hardware, storage 208 may be a physical device that is part of authentication module 200, or accessible to authentication module 200. In a software implementation, storage 208 is accessible to authentication module 200, and authentication module 200 may be required to present credentials in order to access the information in storage 208.

Authentication module 200 includes validation agent 210, which represents one or more functional components or means that enable authentication module 200 to provide validation operations with countermeasures, as described herein. The functions or features of the components include, or are provided by, one or more of double validation module 220 and interleaved validation module 230. Each module may further include other modules to provide specific functionality. In one embodiment modules 220 and 230 are mutually exclusive. As used herein, a module refers to routine, a subsystem, etc., whether implemented in hardware, software, or some combination. One or more modules can be implemented as hardware while other(s) are implemented in software.

Double validation module 220 enables validation agent 210 to provide for a second validation of the public modulus N. The modulus N can be re-confirmed as valid after the validation of the signature S when a fault attack may be suspected to occur. Thus, after validation of S, N can be re-validated to ensure that a proper modulus was used to generate the positive validation of S. Double validation module 220 includes re-computation module 222 that re-calculates the hash or other function used to validate S.

Interleaved validation module 230 enables validation agent 210 to provide a validation of N during the validation of S, which is the signature used to sign the message M. The validation of N during the validation of S may not be a direct validation, as traditionally done. Rather, N may be indirectly validated through the use of computations on values derived from N. In one embodiment, interleaved validation module 230 includes variable generator 232 that generates variables to use in N-based computations not found in traditional authentication routines. The N-based computations with the generated variables validate a received signature, and also validate the public modulus used in the public key. In one embodiment, the variables are generated prior to validation of S. In an alternative embodiment, the variables are generated as part of the S-validation process. For example, variable generator 232 may generate variables that are two check values X and Y, where X and Y satisfy the equation X^{E}Y (mod N_{A})=1, where N_{A} is an expected value of the public modulus N. In an embodiment where the check values X and Y may be computed prior to the authentication procedure (e.g., generated at production time and stored on the authenticating device), variable generator 232 accesses the check values X and Y (e.g., reading the values from a storage device), and provides the check values to other modules for performance of N-based computations with the check values.

Interleaved validation module 230 includes signature decryption module 234 to decrypt the signature with the N-based computations mentioned above, with the variables (also referred to as check values or intermediate values) generated by variable generator 232. More specifically, signature decryption module 234 includes computation module 236 to perform computations associated with the check values. Computation module 236 may perform a computation C=((S·X)^{E}·Y) (mod N), where X and Y are the variables, E is the public exponent, N is the public modulus, and S is the signature. The computation C can be performed as a single equation, or a series of mathematical equivalents. For example, a series of mathematical equivalents may be to compute A=S·X (mod N), then compute B=A^{E} (mod N), and finally, compute C=B·Y (mod N). Signature decryption module 234 may extract an expected value based on the computation performed.

In an alternate interleaving implementation, interleaved validation module 230 decrypts the signature with N-based computations with a single variable generated by variable generator 232. More specifically, a variable U is generated for use in the decryption of the signature. The variable U is derived by generating a random number T, and then multiplying T by the public modulus N. U can be derived prior to validation of N (and then discarded if N fails to validate), during the validation of N, or after the validation of N and prior to the validation of S. During the validation of S computation module 236 of signature decryption module 234 may perform the computation A=(S+U) (mod N), then compute B=A^{E} (mod N). Finally, signature decryption module 234 extracts an expected value based on the computation performed.

In the two interleaving countermeasures described, additional storage, components, and/or computations may be required as compared to conventional RSA authentication. In the two variable interleaving countermeasure described with the intermediate values X and Y, the numbers X and Y need to be stored, which requires additional storage. Furthermore, the two-variable interleaving countermeasure described, two additional modular operations are performed, which is not a negligible increase in the computational burden. With the single variable interleaving countermeasure described with the intermediate value U, a random number generator (either hardware or software, although hardware is generally considered more robust) would be included. Additionally, in one embodiment, the base used in the modular computations may be increased, which should be accommodated by the computational components.

Interleaved validation module 230 includes match determination module 238, which determines whether the expected value extracted by signature decryption module 234 is a match to a test value (a hash of M, typically padded). If the values match, the signature can be deemed to be valid.

As described, the descriptions of agents or modules describe components that may include hardware, software, and/or a combination of these. In a case where a component to perform operations described herein includes software, the software data, instructions, and/or configuration may be provided via an article of manufacture by a machine/electronic device/hardware. An article of manufacture may include a machine readable medium having content to provide instructions, data, etc. The content may result in an electronic device as described herein, performing various operations or executions described. A machine readable medium includes any mechanism that provides (i.e., stores and/or transmits) information/content in a form accessible by a machine (e.g., computing device, electronic device, electronic system/subsystem, etc.). For example, a machine readable medium includes recordable/non-recordable media (e.g., read only memory (ROM), random access memory (RAM), magnetic disk storage media, optical storage media, flash memory devices, etc.). The machine readable medium may further include an electronic device having code loaded on a storage that may be executed when the electronic device is in operation. Thus, delivering an electronic device with such code may be understood as providing the article of manufacture with such content described herein. Furthermore, storing code on a database or other memory location and offering the code for download over a communication medium may be understood as providing the article of manufacture with such content described herein.

FIG. 3 is a flow diagram of an embodiment of a process for doubly validating a public key. A double validation countermeasure can be provided from an authentication module, as described above. The authentication module receives a message M_{R}, signature S_{R}, and modulus N_{R}, 310. The authentication module validates the received modulus N_{R}, 320. Note that validating N_{R} 320 may be optional in one or more implementations. Double validation of N_{R} provides an additional validation of N_{R}, with the second validation occurring after the validation of the signature, where a fault attack may occur. Thus, providing only the validation of N_{R} after the validation of the signature may provide sufficient assurance that success in validating the signature is achieved with a proper N_{R}.

The authentication module computes the hash of the received modulus hN_{R}, 322, and compares hN_{R} to the stored hash of the authentic modulus hN_{A}, or to the hash of the stored authentic modulus hN_{A}, 324, either the hash or the modulus being stored in protected memory. If the two hashes do not match, validation of the received modulus N_{R} fails, 328, and the received modulus is determined to not be valid. If the two hashes match, the received modulus N_{R} is determined to be valid, and the authentication module uses the received modulus N_{R} to complete its public key.

After the public modulus is determined by the authenticating device to be valid, the attacker could induce faults in the authenticating device to change the received modulus N_{R} to N_{F}, 330. If successful, the attacker may be able to cause the authenticating device to use the fake modulus N_{F} instead of the authentic modulus N_{A} to complete its public key for the validation of S.

The authenticating device validates the received signature S_{R}, 340. The authenticating device computes a hash of the received message hM_{R}, 342, and decrypts the received signature S_{R} with public key 345 having E and N_{R} to extract an expected hash Eh, 344. Note that as used herein, generating a hash of M may include operations other than simply hashing the message. Specifically, practical implementations of RSA pad the message string to ensure that the message is a full-length message (e.g., padding a 160 bit message to a full 2048 bit string) for security purposes. The sending of a short message can make the transaction very insecure as compared to the sending of a full-length message. Padding schemes include PKCS v1.5 of the Public Key Cryptography Standards group, Optimal Asymmetric Encryption Padding (OAEP), and Probabilistic Signature Scheme for RSA (RSA-PSS), as is understood by those skilled in the art. Other standards may be used. As mentioned above, padding schemes are generally part of a practical implementation of RSA, but will not be discussed in detail herein. Where padding schemes are used, it will be understood that reference herein to operations involving a hash of M may be understood as including the implementation of a padding scheme, if one is used. Thus, for simplicity in description, padding schemes are ignored, and may be implied where appropriate.

Decrypting the received signature S_{R} may be performed by computing a decrypted result A, where

A=S_{R}^{E}(mod N_{R}). (4)

The authenticating device extracts the expected hash Eh from the results, and compares the expected hash to the hash of the received message hM_{R}, 346. If the hashes do not match, 348, the received signature S_{R} is determined to be not valid and the authentication procedure fails, 349. If the hashes match, 348, the received signature S_{R} is determined to be valid. If the attacker at 330 had been able to change the value of N_{R} from N_{A} to N_{F}, the authenticating device would likely validate the forged signature S_{F}.

However, in one embodiment, the authenticating device includes an authentication module with a double validation countermeasure. In such an implementation, the authenticating device doubly validates the received modulus N_{R}, 360. The operations to double validate N_{R} can be identical to the operations that originally validated N_{R}. In one embodiment, the authenticating device re-computes the hash of the received modulus hN_{R}, 362, and compares the results to an expected hash, for example, a stored hash of authentic modulus hN_{A}, 364. If the hashes do not match, 366, the authenticating device determines that N_{R} has changed since the original validation of N_{R}, 320, and the authentication procedure fails, 368. If the hashes match, 366, the authenticating device deems M_{R} to be authentic, 370, because N_{R} would be unchanged since the original validation of N_{R}, 320.

For the fault attack to succeed with a double validation countermeasure, the attacker must induce additional data faults and change the value of the received modulus N_{R} from N_{F} back to N_{A}, 350, between the time of the validation of S_{R}, 340, and the re-validation of N_{R}, 360. In order to succeed in such an attempt, the attacker must induce additional data faults, which roughly squares the number of attempts the attacker must make to succeed. Therefore, if N_{F} differs from N_{A} by b bits, a successful attack would statistically require the attacker to make roughly (2b)², rather than 2b, attempts. Thus, the double validation countermeasure obstructs fault attacks while being relatively inexpensive and easy to implement. To perform double validation 360, no additional values need to be stored, and the single additional hash calculation and single additional comparison do not significantly increase the authentication computational burden as compared to the standard procedure.

FIG. 4 is a flow diagram of an embodiment of a process for interleaving validation of a public key with validation of a received signature. In one embodiment, the authenticating device includes an authentication module with an interleaved validation countermeasure. The authenticating device receives the message and variables, and the authentication module receives and processes the received information. For the purpose of simplicity in description, the authenticating device will be described as performing various operations, which can be understood as being performed by one or more elements of the authentication module within the authenticating device.

The authenticating device receives message M_{R} and signature S_{R}, 402. The authenticating device determines whether a copy of the authentic modulus N_{A} is stored in memory (e.g., protected memory 130 of FIG. 1), 404. If the authenticating device has a stored copy of N_{A} in memory, 405, the authenticating device retrieves the public key from memory, 406. If the authenticating device does not have a copy of N_{A} in memory, 405, the authenticating device receives a modulus N_{R} from the sender, 408. For a received modulus N_{R}, the authenticating device validates the received modulus N_{R}, 410, prior to including the received modulus as a part of the public key. To validate N_{R}, the authenticating device computes the hash of the received modulus hN_{R}, 412, and compares the result to a trusted hash of the authentic modulus hN_{A}, 414, typically stored in a protected memory on the authenticating device. If the hashes do not match, 416, the received modulus N_{R} is determined to be not valid, and the authentication procedure fails, 418. If the hashes do match, 416, the received modulus N_{R} is determined to be valid, and the authenticating device compiles the public key <N, E> from the public exponent stored in memory and the received modulus N_{R}, 420 (from 416). Alternatively, the public key <N, E> is compiled from the public exponent stored in memory and the stored modulus N_{A}, 420 (from 406). Note that validating the received modulus N_{R}, 410, is optional. The authenticating device may receive modulus N_{R} and use it to compile the public key without validating N_{R}, relying on later computations to validate N_{R}.

After receipt of, and potential authentication of N_{A}, an attacker may attempt to induce data faults to change the value of the modulus N from N_{A} (or N_{R}) to N_{F}, 430. With a successful data fault attack, the attacker could cause the authenticating device to use the fake modulus N_{F} instead of the authentic modulus N_{A} in the public key, which could cause the authenticating device to accept a false message M_{F}. Note that if no authentication of N_{R} is performed, the attacker could cause the authenticating device to use N_{F} without inducing data faults, by sending N_{F} to the authenticating device directly.

Interleaved validation occurs in the validation of the received signature S_{R}, 440. The authenticating device computes a hash of the received message hM_{R}, 442, and decrypts the received signature S_{R}, 450. The authenticating device decrypts S_{R} with one or more computations that rely on an authentic value of the public modulus N. If the public modulus N is not valid (i.e., N has been changed to N_{F} through a data fault attack by the attacker), the authentication of S_{R} will fail. Thus, the message or the signature is validated with computations that validate N. This could also be stated as performing one or more N-based computations that validate or re-validate N. In one embodiment, the authenticating device has pre-computed values X and Y stored in the device. Alternatively, the authenticating device could compute the values X and Y on the fly for use in the validation of S_{R}. X and Y are values selected to satisfy the equation

X^{E}Y(mod N_{A})=1. (4)

The values could be referred to as intermediate values, and are used in conjunction with the public key <N, E> to decrypt the received signature S_{R}, 440. Note that the values are derived from N_{A} as selected with equation (4), 454, 456. To decrypt S_{R}, 450, the authenticating device computes

C=(S_{R}·X)^{E}·Y(mod N), (5)

or a mathematical equivalent. The authenticating device also extracts from the computation an expected hash Eh, 452. The authentication device compares the expected hash Eh extracted from the computation of equation (5) to the hash hM_{R}, 444. If the hashes do not match, 446, S_{R} or N is determined to be invalid, and the authentication procedure fails, 448. If the hashes match, 446, the authenticating device determines that M_{R} is authentic, 460.

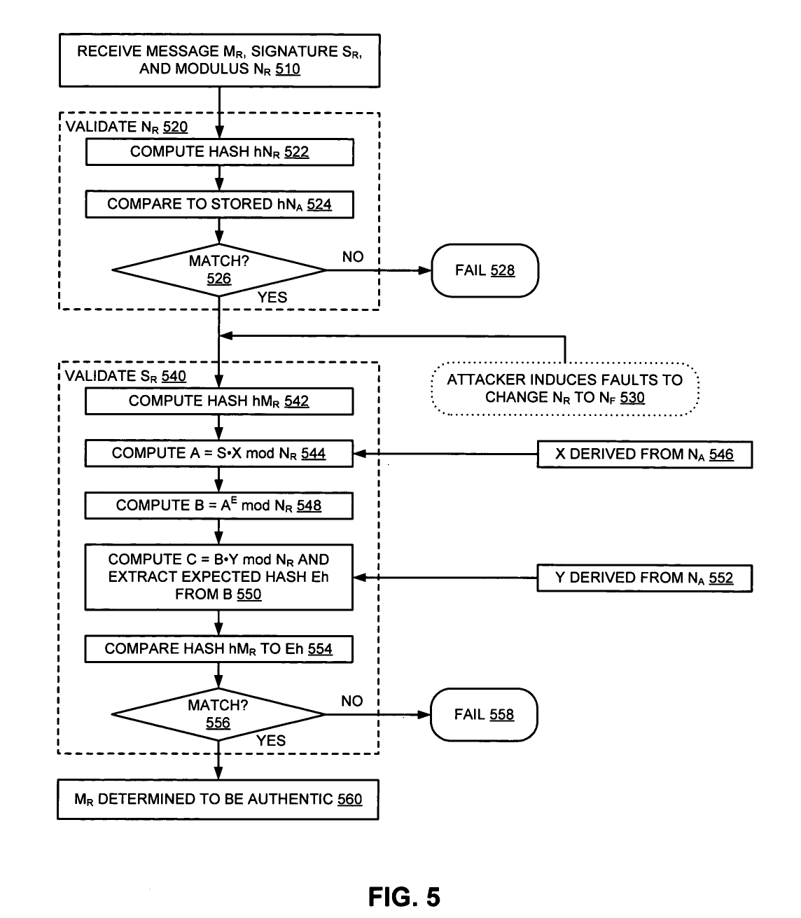

FIG. 5 is a flow diagram of an embodiment of a process for interleaving validation of a public key with validation of a received signature with computations derived from a trusted public key value. In one embodiment, the authenticating device includes an authentication module with an interleaved validation countermeasure. The authenticating device receives message M_{R}, signature S_{R}, and modulus N_{R}, 510. As noted in FIG. 4, the modulus may not be received, and the process of validating N_{R} is optional. Assuming the modulus N_{R} is received, and validated, 520, the authenticating device computes the hash of the received modulus hN_{R}, 522, and compares the result to a trusted hash of the authentic modulus hN_{A}, 524. If the hashes do not match, 526, the received modulus N_{R} is determined to be not valid, and the authentication procedure fails, 528. If the hashes do match, 526, the received modulus N_{R} is determined to be valid, and the authenticating device proceeds to validate S_{R}, 540, with the received modulus N_{R}.

An attacker may attempt to induce data faults to change the value of the modulus N from N_{A} (or N_{R}) to N_{F}, 530. As described previously, a successful data fault attack may enable the attacker to cause the authenticating device to accept a false message M_{F}. Interleaved validation occurs in the validation of the received signature S_{R}, 540. The authenticating device computes a hash of the received message hM_{R}, 542, and then performs various operations to decrypt the received signature S_{R} and concurrently test the validity of the received modulus N_{R}.

As above in FIG. 4, the values X and Y can be pre-computed or generated on the fly. The values can be referred to as intermediate values, and are derived from N. Operations with the intermediate values X and Y are N-based computations. X and Y are values selected to satisfy the equation

X^{E}Y(mod N_{A})=1. (4)

The values X and Y are thus derived from N, 546, 552. As illustrated in FIG. 5, the authenticating device decrypts S_{R} by performing operations that are the mathematical equivalent of equation (5), which is described as being computed in FIG. 4 to decrypt S_{R}. The computation performed in equation (5) may be broken into multiple separate computations. For example, the authenticating device may compute

A=S·X(mod N), (6)

with the intermediate value X, 544, and use A to compute

B=A^{E}(mod N), (7)

which is based on the intermediate value, 548. The authenticating device completes the series of computations by using B to compute

C=B·Y(mod N), (8)

which uses the intermediate value of Y, 550, and provide the equivalent of multiplying the equation by 1.

If N equals N_{A}, then equation (5) is mathematically equivalent to the traditional decryption calculation of equation (2). However, if the value of N does not equal N_{A}, equation (5) will not yield the same result as the traditional decryption calculation of equation (2). Consider the following:

(S_{R}·X)^{E}·Y(mod N)=S_{R}^{E}(mod N), (9)

because

(S_{R}·X)^{E}·Y(mod N)=[X^{E}Y(mod N)]·[S_{R}^{E}(mod N)], (10)

and if N=N_{A}, then

X^{E}Y(mod N)=1, (11)

because X and Y were selected to satisfy equation (11) where N=N_{A}, and therefore

[X^{E}Y(mod N)]·[S_{R}^{E}(mod N)]=S_{R}^{E}(mod N). (12)

### However, if N has been changed from N_{A} to N_{F} by the attacker, then

(S_{R}·X)^{E}·Y(mod N)≠S_{R}^{E}(mod N), (13)

because of a very high statistical probability that

X^{E}Y(mod N_{F})≠1. (14)

### Therefore, even if the attacker is able to change the value of N from N_{A} to N_{F}, the authenticating device will not validate forged signature S_{F} with the validation provided in 540.

To provide the statistical improbability that a fault attack could work when the authenticating device validates S_{R} according to 540, the values X and Y must be kept private. If the attacker knows the values of X and Y, a fake modulus N_{F}, and a forged signature S_{F} may be found that satisfy the equation

hM_{F}=(S_{F}·X)^{E}·Y(mod N_{F}), (15)

and defeat the interleaved validation countermeasure. In one embodiment, X and Y are computed at production time and stored in a protected memory with the public key components. Among other possible methods of selecting X and Y, the following is one example. A random value X is selected. After selecting X, a corresponding value for Y can be derived by computing the two equations

V=X^{E}mod N, (16)

and then

Y=V⁻¹mod N. (17)

Thus, as described above, the authenticating device computes equation (6), 544, equation (7), 548, and equation (8), from which an expected hash value Eh is extracted from B, 552. As noted above, X is derived from N_{A}, 546, and Y is derived from N_{A}, 552. The expected hash Eh and the hash of M hM_{R} are compared, 554. If the values do not match, 556, the authentication procedure fails, 558. If the values match, 556, M_{R} is determined to be authentic, 560.

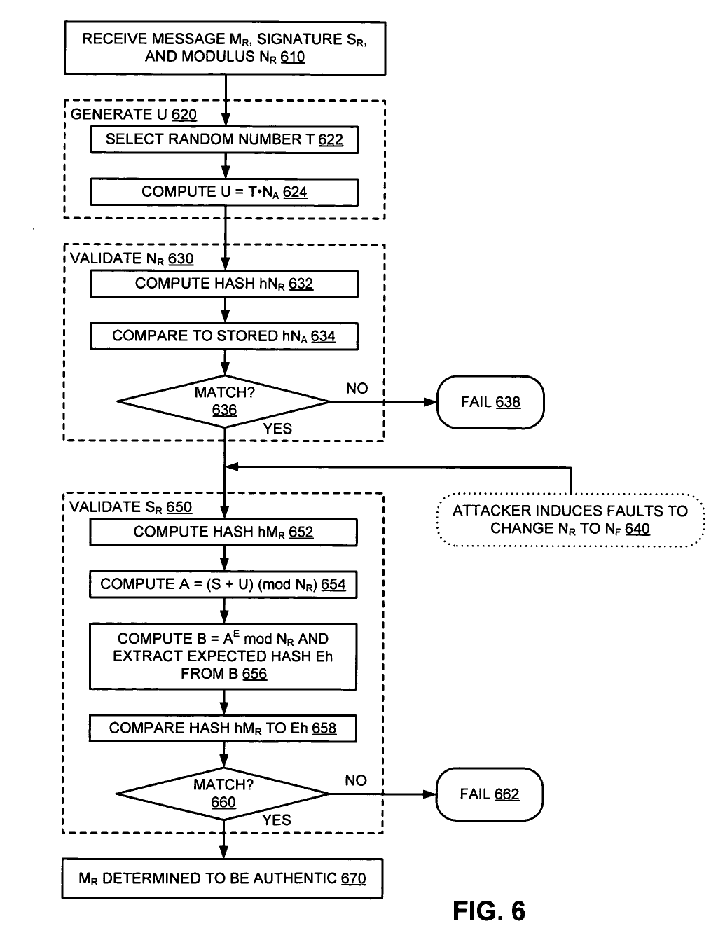

FIG. 6 is a flow diagram of an embodiment of a process for interleaving validation of a public key with validation of a received signature with computations derived from a trusted public key value. In one embodiment, the authenticating device includes an authentication module with an interleaved validation countermeasure. The authenticating device receives message M_{R}, signature S_{R}, and modulus N_{R}, 610. For the interleaving implementation of FIG. 6, a variable U is generated, 620. Note that the variable U may be generated prior to, during, or after validation of N_{R}, 630, assuming N_{R} is validated. Otherwise, U may be generated any time prior to validation of S_{R}, 650, but prior to a time that the attacker may attempt to change N_{R} to N_{F}.

To generate U, the authenticating device selects a random number T, 622. T may be selected with any of a number of known techniques or random number generation engines. The authenticating device then computes U based upon N, 624. For example the authenticating device may compute

U=T·N. (18)

where N is either N_{R} or N_{A}, depending on which value the authenticating device is using.

As noted in FIG. 4, the modulus may not be received, and the process of validating N_{R} is optional. Assuming the modulus N_{R} is received, and validated, 630, the authenticating device computes the hash of the received modulus hN_{R}, 632, and compares the result to a trusted hash of the authentic modulus hN_{A}, 634. If the hashes do not match, 636, the received modulus N_{R} is determined to be not valid, and the authentication procedure fails, 638. If the hashes do match, 636, the received modulus N_{R} is determined to be valid, and the authenticating device proceeds to validate S_{R}, 650, with the received modulus N_{R}.

An attacker may attempt to induce data faults to change the value of the modulus N from N_{A} (or N_{R}) to N_{F}, 640. As described previously, a successful data fault attack may enable the attacker to cause the authenticating device to accept a false message M_{F}. Interleaved validation occurs in the validation of the received signature S_{R}, 650. The authenticating device computes a hash of the received message hM_{R}, 652, and then performs various operations to decrypt the received signature S_{R} and concurrently test the validity of the received modulus N_{R}.

As illustrated in FIG. 6, the authenticating device decrypts S_{R} by performing operations that also validate N by using computation terms that are derived from N. In this example, the authenticating device computes

A=(S+U)(mod N), (19)

which is dependent upon the value U, 654. The authenticating device uses A to compute

B=A^{E}(mod N), (20)

If N equals N_{A}, then equation (20) is mathematically equivalent to the traditional decryption calculation of equation (2). However, if the value of N does not equal N_{A}, equation (20) will not yield the same result as the traditional decryption calculation of equation (2). Consider the following:

U(mod N)=(T·N)(mod N)=0. (21)

### Thus,

(S_{R}+U)(mod N)=S_{R}mod N+Umod N=S_{R}mod N. (22)

### However, it is very unlikely that

U(mod N_{F})=0, (23)

and therefore

(S_{F}+U)(mod N_{F})=S_{F}mod N_{F}+Umod N_{F}≠S_{F}mod N_{F}, (24)

with very high statistical probability. Therefore, even if the attacker is able to change the value of N from N_{A} to N_{F}, the authenticating device will not validate forged signature S_{F} with the validation provided in 650.

Thus, B is computed, and an expected hash value Eh is extracted from B, 656. The expected hash Eh and the hash of M hM_{R} are compared, 658. If the values do not match, 660, the authentication procedure fails, 662. If the values match, 660, M_{R} is determined to be authentic, 670.

Flow diagrams as illustrated herein provide examples of sequences of various operations. Although shown in a particular sequence or order, unless otherwise specified, the order of the operations can be modified. Thus, the illustrated implementations should be understood only as examples, and operations can be performed in a different order, and some operations may be performed in parallel or alternatively performed only implicitly by way of logical simplification. Other operations, orders of operations, flowcharts and embodiments are also within the scope of the present invention.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for obstructing a fault-based attack of digital message authentication, comprising:
accessing a digital message M, a signature S, and a modulus N, where the signature S is to sign the digital message M, and the modulus N is a public modulus for modular authentication operations;
validating N; and
after validating N, performing an N-based computation that re-validates N.

2. The method of claim 1, wherein validating N comprises:
computing a hash value of N; and
comparing the computed hash value of N to an expected value; and
wherein performing the N-based computation that re-validates N comprises:
re-computing a hash value of N; and
comparing the re-computed hash value of N to the expected value.

3. The method of claim 1, wherein performing the N-based computation that re-validates N comprises:
validating M and, during the validating of M, performing an intermediate value computation based on N to result in an intermediate value for a validation computation of M.

4. The method of claim 3, wherein performing the intermediate value computation based on N comprises:
computing a check value derived from an expected value N_{A}.

5. A method for obstructing a fault-based attack of digital message authentication, comprising:
accessing a digital message M, a signature S, and a modulus N, where the signature S is to sign the digital message M, and the modulus N is a public modulus for modular authentication computations; and
validating S, including performing at least one N-based computation that validates N.

6. The method of claim 5, wherein performing the N-based computation comprises:
performing an N-based computation with one or more check values, wherein the check values are derived from an expected value N_{A}.

7. The method of claim 6, wherein the one or more check values are derived from the expected value N_{A} at production time, and further comprising:
storing the one or more check values in a protected memory.

8. The method of claim 6, wherein accessing the digital message M, the signature S, and the modulus N comprises:
accessing the message M signed in accordance with the Rivest, Shamir, and Adleman (RSA) algorithm for signature authentication, where the modulus N and a public exponent E constitute a public key that corresponds to a private key, the private key including the modulus N, where the signature S includes a hash value of M encrypted with the private key; and
wherein validating M comprises:
computing a hash of M;
decrypting S with the public key, including performing the N-based computation with the one or more check values; and
comparing the decrypted result to the hash of M.

9. The method of claim 8, wherein the one or more check values comprise two check values X and Y, wherein X and Y satisfy the equation X^{E}Y (mod N_{A})=1, where N_{A} is an expected value of N.

10. The method of claim 9, wherein the two check values X and Y are derived by:
selecting a value for X;
computing an intermediary value V, wherein V satisfies the equation V=X^{E} (mod N_{A}); and
computing a value for Y, wherein Y satisfies the equation Y=V⁻¹ (mod N_{A}).

11. The method of claim 9, wherein decrypting S with the public key, including the N-based computation with the one or more check values comprises:
computing a value C, wherein C=((S·X)^{E}·Y) (mod N).

12. The method of claim 9, wherein decrypting S with the public key, including the N-based computation with the one or more check values comprises:
computing a value A, wherein A=S·X (mod N);
computing a value B, wherein B=A^{E} (mod N); and
computing a value C, wherein C=B·Y (mod N).

13. The method of claim 6, wherein the one or more check values comprise one check value U, wherein U is derived from the equation U=T·N_{A}, where T is a random number, and N_{A} is an expected value of N.

14. The method of claim 9, wherein decrypting S with the public key, including the N-based computation with the one or more check values comprises:
computing a value A, wherein A=(S+U) (mod N); and
computing a value B, wherein B=A^{E} (mod N).

15. The method of claim 5, wherein accessing a message M, a signature S, and a modulus N comprises:
receiving the message M and signature S from a user; and
retrieving N from a protected memory.

16. An article of manufacture comprising a machine-readable medium having content stored thereon to provide instructions to cause a device to perform operations, including:
accessing a digital message M, a signature S, and a modulus N, where the signature S is to sign the digital message M, and the modulus N is a public modulus for modular authentication computations; and
validating S, including performing at least one N-based computation with one or more check values derived from a value N_{A} that is an expected value of N.

17. The article of manufacture of claim 16, wherein the content to provide instructions for accessing the digital message M, the signature S, and the modulus N comprises content to provide instructions for:
accessing the message M signed in accordance with the Rivest, Shamir, and Adleman (RSA) algorithm for signature authentication, where the modulus N and a public exponent E constitute a public key that corresponds to a private key, the private key including the modulus N, where the signature S includes a hash value of M encrypted with the private key; and
wherein the content to provide instructions for validating M comprises content to provide instructions for:
computing a hash of M;
decrypting S with the public key, including performing an N-based computation with one or more check values, wherein the check values are derived from an expected value N_{A}; and
comparing the decrypted result to the hash of M.

18. The article of manufacture of claim 16, wherein the one or more check values comprise two check values X and Y, wherein X and Y satisfy the equation X^{E}Y (mod N_{A})=1, where N_{A} is an expected value of N.

19. The article of manufacture of claim 18, wherein the content to provide instructions for decrypting S with the public key, including the N-based computation with the one or more check values comprises content to provide instructions for:
computing a value A, wherein A=S·X (mod N);
computing a value B, wherein B=A^{E} (mod N); and
computing a value C, wherein C=B·Y (mod N).

20. The article of manufacture of claim 16, wherein the content to provide instructions for decrypting S with the public key, including the N-based computation with the one or more check values comprises content to provide instructions for:
deriving U=T·N_{A}, where T is a random number, and N_{A} is an expected value of N;
computing a value A, wherein A=(S+U) (mod N); and
computing a value B, wherein B=A^{E} (mod N).

21. An authenticating device comprising:
a dynamic random access memory (DRAM) to store a message M for authentication, and a signature S; and
a validation agent coupled to the DRAM to validate the signature S, the validation agent having a variable generator to access an intermediate value derived from a trusted public modulus N_{A}; a signature decryption module coupled to the variable generator to perform an N-based computation with the accessed intermediate value to decrypt S; and a match determination module coupled to the signature decryption module to determine if the decryption of S results in an expected value.

22. The authenticating device of claim 21, wherein the variable generator generates the intermediate value.

23. The authenticating device of claim 21, wherein the signature decryption module further comprises:
a computation module to perform an N-based computation of C=((S·X)^{E}·Y) (mod N), wherein X and Y are intermediate values accessed by the variable generator.
